(19) United States
(12) Patent Application Publication
(10) Pub. No.: US 2019/0191669 A1
(43) Pub. Date: Jun. 27, 2019

(54) PET WASTE COLLECTION SYSTEM

(71) Applicant: Katherine Heatley, Dorchester, MA (US)

(72) Inventor: Katherine Heatley, Dorchester, MA (US)

(21) Appl. No.: 16/229,029

(22) Filed: Dec. 21, 2018

Related U.S. Application Data
(60) Provisional application No. 62/609,833, filed on Dec. 22, 2017.

(51) Int. Cl. A01K 23/00

(52) U.S. Cl. CPC A01K 23/005; A01K 1/01

(57) ABSTRACT

Provided herein are improved pet accessory waste collection systems.

### RELATED APPLICATIONS

This application claims the benefit of priority to U.S. Provisional Application No. 62/609,833, filed Dec. 22, 2017, the entire contents of which are incorporated herein by reference.

### BACKGROUND

In addition to holding pet restraining devices such as leases and harnesses, those who walk dogs or other pets often need to carry both pet accessories (e.g., dog treats, excrement pickup bags, etc.) and personal items (e.g., keys, a phone, a wallet, etc.). This can be burdensome, particularly in instances where multiple animals are being handled at one time, and often leads to items being misplaced and unorganized. A pet waste collection system that is suitable for retrieving and holding pet waste in a sanitary and discreet manner, and which is suitable for holding pet accessories (e.g., waste litter bags) and personal items all under the same system, provides a convenient and effective solution for housing multiple articles at one time.

### SUMMARY

Provided herein is an animal waste collection system that is suitable for holding pet waste in a sanitary and discreet manner and for safely storing personal items. The collection system may be configured to be carried by the pet owner or attached to a pet restraining device or pet collar.

The disclosed animal waste collection system (e.g., pet accessory bag) is suitable for temporarily storing retrieved pet waste (e.g., used waste litter bags containing pet animal waste) in a drawstring pouch contained within the bag. The drawstring pouch may be configured and adapted to attached within an opening of the system (e.g., pet accessory bag). In an exemplary embodiment, a filter sachet (e.g., charcoal filter sachet or any other suitable odor filter) may be mounted to an inner portion of the drawstring pouch. Filter sachet may be used to neutralize or lessen the odor caused by fecal animal waste temporarily stored in the drawstring pouch by a user (e.g., pet owner).

An exemplary embodiment of the present disclosure may comprise a pet waste accessory bag. The bag may comprise an elongate body having a first end and a second end, the elongate body may include an opening extending substantially from the first end to the second end; a drawstring pouch mounted to a surface of the elongate body, wherein the drawstring pouch may be configured and dimensioned to receive at least one bag of pet waste; and a mesh pocket mounted to an inner surface of the drawstring pouch and located within the opening, wherein the mesh pocket may be configured to receive a filter sachet.

Another exemplary embodiment of the present disclosure may comprise a pet waste collection system. The system may comprise a pet accessory bag comprising: an elongate body having a first end and a second end, the elongate body may include an opening extending substantially from the first end to the second end; a first compartment located at the first end, wherein a first dividing wall may be configured to separate the opening with the first compartment; a second compartment located at the second end, wherein a second dividing wall may be configured to separate the opening with the second compartment; a lid pivotally attached to the elongate body; a bag comprising a first section and a second section, wherein the bag first section may be mounted to a base of the elongate body; and a pocket mounted to an inner surface of the bag first section, wherein the pocket may be configured and dimensioned to receive an odor filter.

### BRIEF DESCRIPTION OF THE DRAWINGS

The accompanying drawings illustrate the teachings taught herein and are not intended to show relative sizes and dimensions, or to limit the scope of examples or embodiments. In the drawings, the same numbers are used throughout the drawings to reference like features and components of like function.

FIG. 1 is a perspective view of a pet waste collection system (e.g., pet waste collection accessory bag) in accordance with an embodiment of the present disclosure.

FIG. 2 is a top plan view of the exemplary pet waste collection system of FIG. 1 depicting a closeable lid in a closed position.

FIG. 3 is a bottom plan view of the exemplary pet waste collection system of FIG. 1.

FIG. 4 is a front plan view of the exemplary pet waste collection system of FIG. 1.

FIG. 5 is a rear plan view of the exemplary pet waste collection system of FIG. 1.

FIG. 6 is a first end view of the exemplary pet waste collection system of FIG. 1.

FIG. 7 is a second end view of the exemplary pet waste collection system of FIG. 1.

FIG. 8 is a top plan view of the exemplary pet waste collection system of FIG. 1 depicting the closeable lid in an open position and further depicting a drawstring bag.

FIG. 9A is a perspective view of the exemplary pet waste collection system of FIG. 1 depicting the drawstring bag in a closed position.

FIG. 9B is a perspective view of the exemplary pet waste collection system of FIG. 1 depicting the drawstring bag in an open position.

FIG. 10A is an enlarged view of the drawstring bag of the exemplary pet waste collection system of FIG. 1 depicting the drawstring bag in the open position and a mesh pocket configured to hold a charcoal filter sachet.

FIG. 10B is a perspective view of the exemplary pet waste collection system of FIG. 1.

FIG. 11 is a perspective view of the exemplary pet waste collection system of FIG. 1.

FIG. 12 is a perspective bottom view of the exemplary pet waste collection system of FIG. 1.

FIG. 13 is the second end view of the exemplary pet waste collection system of FIG. 7.

FIG. 14 is the first end view of the exemplary pet waste collection system of FIG. 6.

FIG. 15 is a perspective view of the exemplary pet waste collection system of FIG. 1 depicting the system in an expanded configuration.

FIG. 16 is a perspective view of the exemplary pet waste collection system of FIG. 1.

FIG. 17 is a perspective view of the exemplary pet waste collection system of FIG. 1 depicting the system in an expanded configuration.

FIG. 18 is a perspective view of the exemplary pet waste collection system of FIG. 1 depicting an opening configured to supply disposable pet waste collections bags.

FIG. 19 is a perspective bottom view of the exemplary pet waste collection system of FIG. 1.

FIG. 20 is a perspective view of the exemplary pet waste collection system of FIG. 1.

FIG. 21 is a perspective bottom view of the exemplary pet waste collection system of FIG. 1.

FIG. 22 is a perspective view of the exemplary pet waste collection system of FIG. 1 depicting the system in an expanded configuration.

### DETAILED DESCRIPTION

Provided herein is a pet waste collection accessory bag that is capable of storing pet waste sanitarily and holding pet accessories and/or personal items. The disclosed accessory bag may be compartmentalized, expandable, adjustably closable and sealable, capable of temporarily storing pet waste, capable of holding and dispensing a supply of fresh pet waste bags (e.g., plastic litter bags, etc.), suitable for holding retrieved pet waste, and suitable for safely storing personal items of the pet owner. The accessory bag may be configured to be carried by either the pet owner or attached to the pet leash or pet collar.

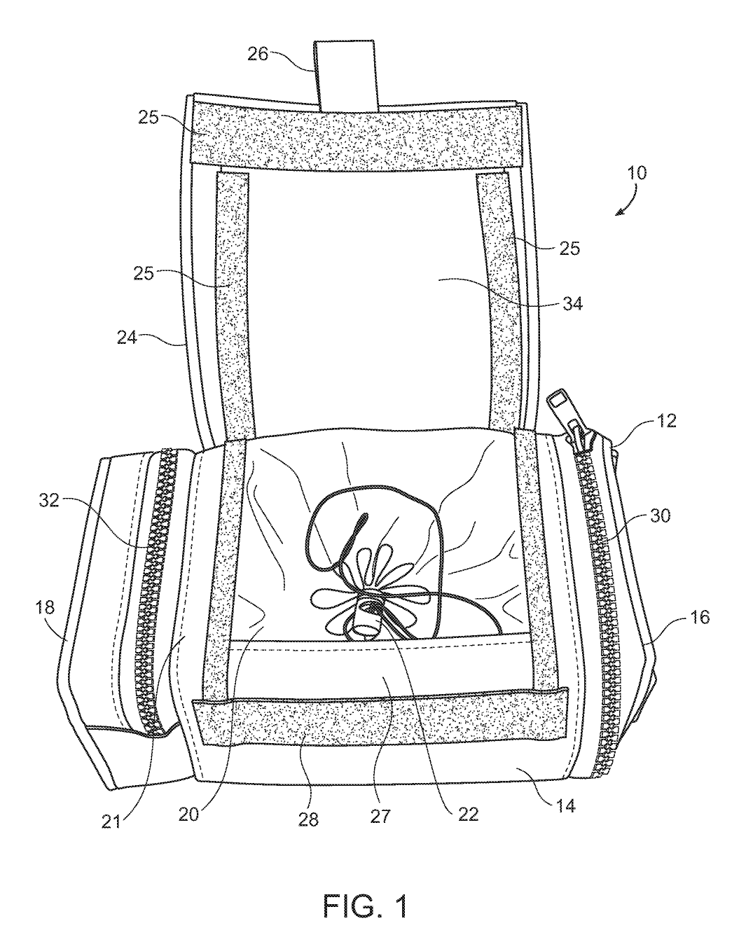

With initial reference to FIG. 1, an exemplary pet waste collection system 10 is depicted. System 10 may include a bag 12. Bag 12 may comprise an elongate body 14 having a first end 16 and a second end 18. Elongate body 14, including first end 16 and second end 18, may comprise a generally rectangular shape, as depicted in FIG. 1. Elongate body 14 may include an opening 20 on a panel 21 of elongate body 14. Panel 21 may be referred to as a top panel or upper panel when bag 12 is orientated as shown in FIG. 1. Bag 12, specifically, elongate body 14 may be comprised of a 500 D PU backed waterproof material (e.g., 95% nylon, 5% cotton). Similarly, other portions of bag 12 may be comprised of a similar material.

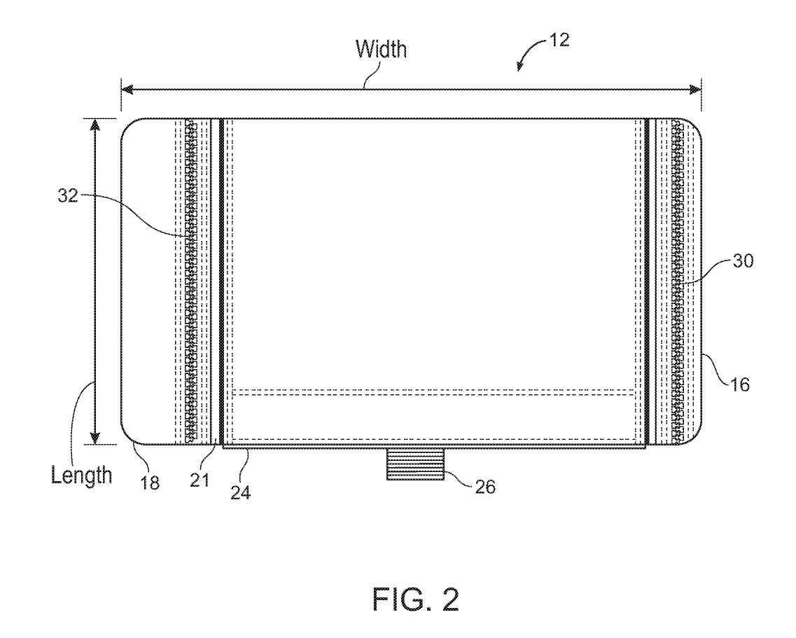

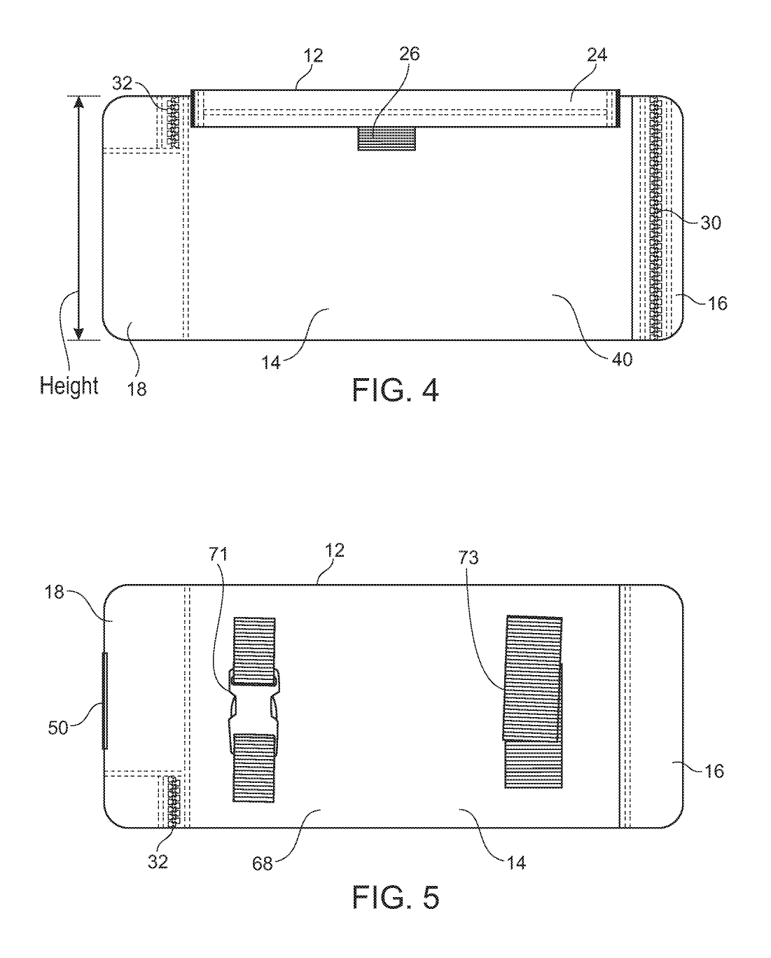

For purposes of geometric reference, and throughout this disclosure, width and length of bag 12 are defined as shown in FIG. 2, and height of bag 12 is defined as shown in FIG. 4.

Opening 20 may extend substantially through a central portion of elongate body 14. For example, in an embodiment, “substantially” may include opening 20 extending from first end 16 to second end 18. In other embodiments, opening 20 may extend only through only a portion of elongate body 14. In some embodiments, and as shown in FIG. 1, opening 20 may be located centrally on panel 21 of bag 12. Opening 20 may be disposed at an edge of panel 21, as shown. Opening 20 may be rectangular in shape with dimensions of about 10 cm in length, 12 cm in width, and approximately 7.62 cm in depth. In this example, the width of opening 20 is parallel to a longitudinal axis of elongate body 14. In some embodiments, the depth may be approximately 5 cm. In other embodiments, the depth of opening 20 may range from 8 cm to 10 cm. In some embodiments, the length of opening 20 may range from 5 cm to 15 cm. In some embodiments, the width of opening 20 may range from 7 cm to 17 cm. In some embodiments, opening 20 may be generally square in shape.

As shown in FIG. 1, elongate body 14 may also include a closeable lid 24 for closing opening 20. Lid 24 may also be a flap in some embodiments. For example, lid 24 may be rectangular in shape with dimensions of about 15 cm in length and 14 cm in width. FIG. 2 depicts lid 24 in a closed position over opening 20 to illustrate a generally rectangular shape. Lid 24 may also be configured to include a tab 26 that may permit a user (e.g., pet owner) to pull lid 24 open or close thereby opening or closing opening 20. Tab 26 may be comprised of a material (e.g., fabric) similar to the material comprising lid 24. In some embodiments, tab 26 comprises a pull loop. In an embodiment, lid 24 may be sized to include a cross-sectional area slightly larger than the cross-sectional area of opening 20. In an exemplary embodiment, lid 24 may be 14 cm in width and 15 cm in length. As shown in FIGS. 2 and 4, lid 24, when closed, may extend to an outer edge of panel 21 and may wrap around elongate body 14 to connect with a front panel 40. In some embodiments, a transparent label holder 34 may also be disposed on an inner face of lid 24, as shown in FIG. 1. Label holder 34 may be configured to hold a care label for care instructions of bag 12, or for any other suitable instructions regarding the use of system 10.

With continued reference to FIG. 2, in some embodiments, bag 12 may be oriented so that second end 18 may be referred to as the “top” of bag 12 and first end 16 may be referred to as the “bottom” of bag 12. This orientation may occur when bag 12 is secured to a pet (e.g., secured to a pet's collar or leash, etc.).

When lid 12 is closed, as shown in FIG. 2, top panel 21, including closed lid 24 and first and second ends 16, 18, may comprise a cross-sectional area of approximately 20 cm in width and 11.5 cm in length.

One or more releasable fasteners 25 may be used to fasten lid 24 to panel 21. Fasteners 25 may be disposed along a perimeter of the inner face of lid 24, as shown in FIG. 1. Corresponding fasteners 25 may be disposed along top panel 21 adjacent an outer perimeter of opening 20, as shown. Taken together, fasteners 25 of lid 24 and fasteners 25 of panel 21 may be used to close lid 24 to elongate body 14 so that opening 20 may be covered. In an exemplary embodiment, fasteners 25 may comprise hook-and-loop fasteners, lineal fabric strips with tiny hooks such as VELCRO®, buttons, clips, buckles, or any other suitable releasable fastener. In some embodiments, a releasable fastener 28 may be disposed along a width of elongate body 14 on front panel 40 of bag 12, as shown in FIGS. 1 and 4. In this example, lid 24 may be sized appropriately so that lid 24, when closed, may cover opening 20 and may be releasably fastened to front panel 40 via fastener 28.

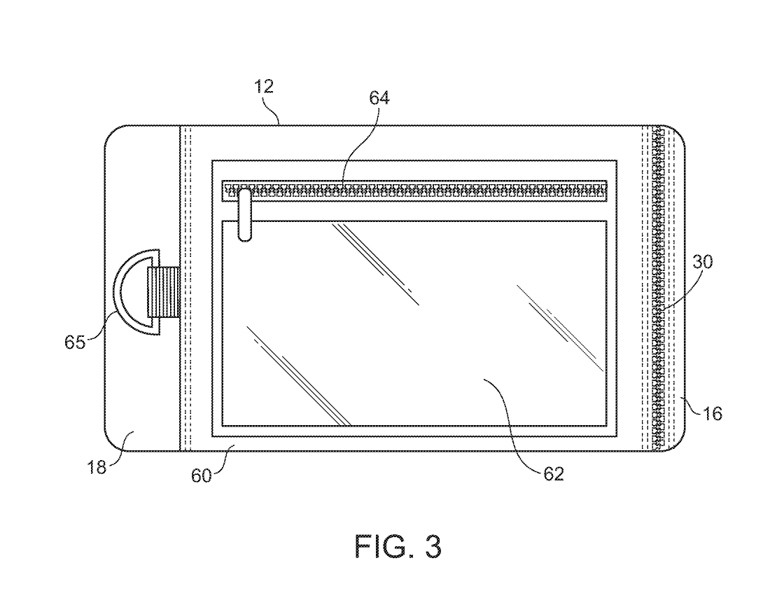

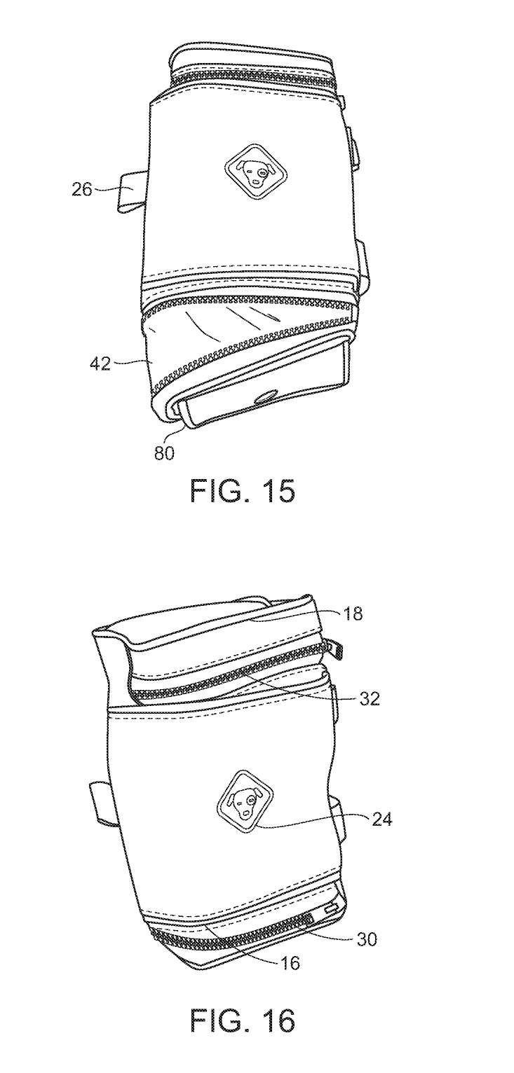

With continuing reference to FIGS. 1 and 2, zip fasteners (e.g., zippers) 30, 32 may be disposed at elongate body first and second ends 16, 18, respectively. In some embodiments, zip fasteners 30, 32 may be clasp lockers or other suitable fastener. Zip fastener 30 may be disposed around at least a portion of first end 16 as depicted in FIG. 1. In an exemplary embodiment, zip fastener 30 may be disposed around the entire periphery of first end 16. In other embodiments, zip fastener 30 may be disposed around at least a portion of the periphery of first end 16, as shown in the figures. Zip fastener 30 may be unzipped to open a first compartment 42 (best shown in FIG. 15). In some embodiments, first compartment 42 may be expandable and may permit elongate bag 12 to expand in a longitudinal direction away the center of bag 12. In an exemplary embodiment, first compartment 42 may expand seven cm in total when zip fastener 30 is fully opened (i.e. unzipped). Expandable first compartment 42 may be configured to store a user's personal items (e.g., a pet owner's driver's license, ID cards, credit cards, keys, or any other suitable personal item). In an exemplary embodiment, expandable first end 16 may be comprised of a waterproof PU nylon material. The size and dimensions of first end 16, including the length and location of zip fastener 30, may be adjusted to accommodate a larger or smaller expandable first compartment 42. As shown in FIG. 3, fastener 30, on first end 16 of bag 12, may be configured and dimensioned to allow first compartment 42 to expand. In other words, fastener 30, when unzipped, may permit first compartment 42 to expand.

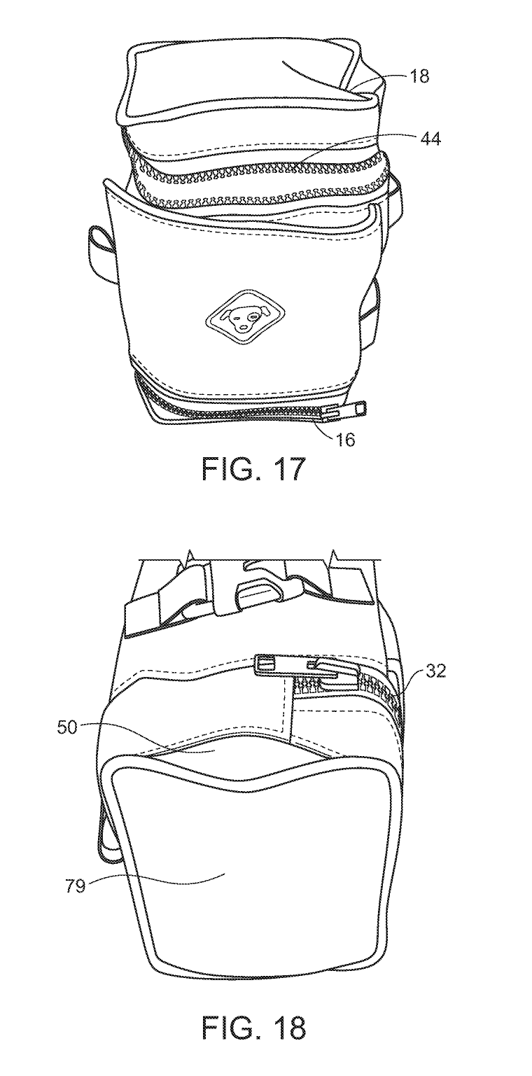

Zip fastener 32 may be disposed partially around second end 18 of elongate body 14, as previously described. In an exemplary embodiment, zip fastener 32 may be disposed around a portion of the periphery of second end 18. Zip fastener 32 may configured and dimensioned to be unzipped to open a second compartment 44 (best shown in FIG. 17). In some embodiments, second compartment 44 may be expandable and may permit elongate bag 12 to expand in a longitudinal direction away the center of bag 12 and opposite of the direction in which first compartment 42 extends. Once in the unzipped and expanded configuration, second compartment 44 may be configured to store a supply of fresh pet animal waste bags (e.g., pet owner's animal waste collection bags, litter bags, doggy bags, etc.). Second compartment 44 may further include an opening 50 (best shown in FIG. 18) to permit a user to retrieve a fresh waste bag individually and as needed. In this example, opening 50 may be configured to dispense a bag individually to the user (e.g., pet owner dispensing a fresh litter bag when collecting deposited animal waste). In an exemplary embodiment, expandable second end 18 may be comprised of a waterproof PU nylon material. The size and dimensions of second end 18, including the length and location of zip fastener 32, may be adjusted to accommodate a larger or smaller expandable second compartment 44.

With reference now to FIG. 3, a bottom panel 60 of bag 12 is now described. Bottom panel 60 may include a transparent pocket 62 that may be configured to open or close using a releasable fastener 64 (e.g., chain zipper), as shown. Transparent pocket 62 may be comprised of a clear material (e.g., clear PVC or some similar transparent plastic, etc.) so that pocket 62 may hold the user's personal items (e.g., driver's licenses, credit cards, ID cards, business cards, pet animal ID cards, etc.). In some embodiments, pocket 62 may be configured to store pet animal treats (e.g., doggy treats, etc.). In an exemplary embodiment, edges of pocket 62 may be bound to fabric of bottom panel 60 (e.g., stitching). In an exemplary embodiment, pocket 62 may be comprised of crystal clear PVC, 150 microns. In an exemplary embodiment, fastener 64 may be configured to open or close pocket 62 to permit the user to insert said personal items and/or said animal treats. In an exemplary embodiment, transparent pocket 62 may be sized to substantially cover a portion of bottom panel 60, as shown in FIG. 3 (e.g., 9 cm in length, 13 cm in width). In an exemplary embodiment, bottom panel 60 of bag 12 may be 20 cm in width and 11.5 cm in length.

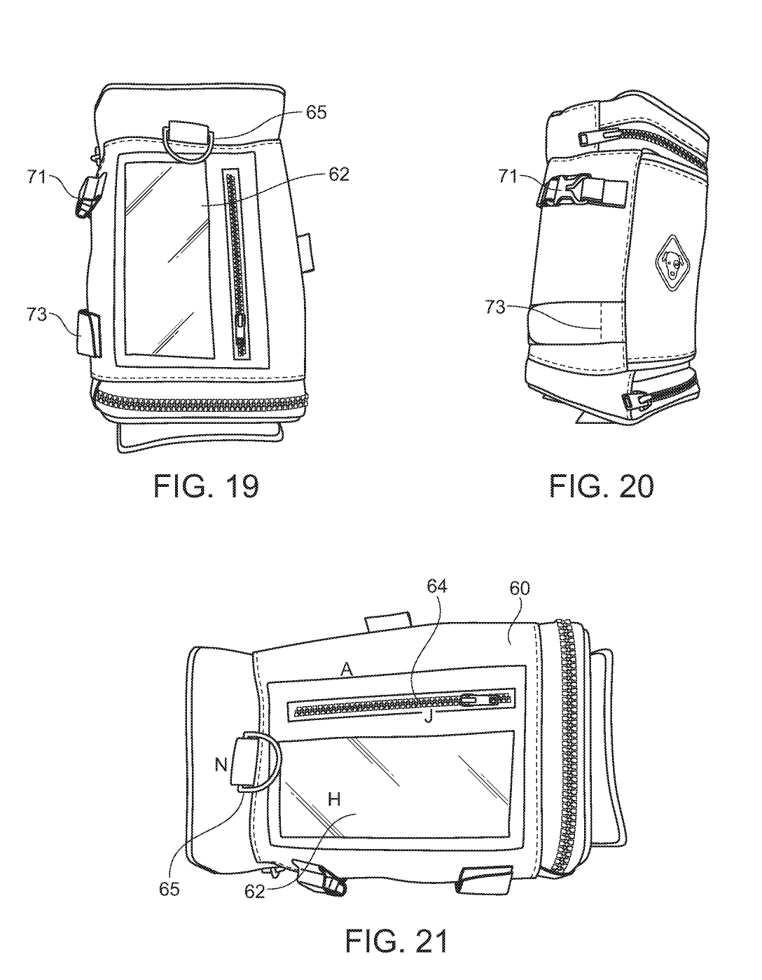

Bottom panel 60 may further include a ring 65, as depicted in FIG. 3. In an exemplary embodiment, ring 65 may be comprised of plastic and be shaped as the letter ‘D.’ Ring 65 may be secured to second end 18 of bag 12. The user (e.g., pet owner) may use ring 65 to secure personal items, including keys, etc. Ring 65 may also be used to releasably couple bag 12 with a separate device (e.g., releasably couple bag 12 to a pet owner's leash, releasably couple bag 12 to pet animal collar, etc.). In an embodiment, ring 25 may be approximately 25 mm in length. In some embodiments, ring 25 may be approximately 25 mm in width. In an exemplary embodiment, ring 65 may be secured to bottom panel 60 employing a loop of fabric secured to panel 60, as depicted. In some embodiments, ring 65 may be attached within a seam of bag 12, as shown in FIG. 19. Reinforced stitching and/or additional fabric may be used to secure the loop of fabric to prevent ring 65 from breakage when ring 65 is coupled to a pet animal. In an embodiment, ring 65 may be disposed on second end 18, as shown in FIG. 3, and associated with second compartment 44, which may be used to store the fresh supply of pet animal waste bags (e.g., doggy litter bags).

With continued reference to FIG. 3, in some embodiments, bag 12 may be oriented so that second end 18 may be referred to as the “top” of bag 12 and first end 16 may be referred to as the “bottom” of bag 12. This orientation may occur when bag 12 is secured to a pet (e.g., secured to a pet's collar or leash, etc.).

With continuing reference to FIGS. 4 and 5, front and rear plan views of bag 12 of FIG. 1 are shown. FIG. 4 depicts a front view of bag 12 further depicting first and second ends 16, 18 of elongate body 14. As alluded to earlier in this disclosure, height of bag 12 is shown for geometrical reference. In an embodiment, zip fastener 30 may be disposed along at least the entire height of bag 12 of front panel 40, as shown. Fastener 30 may be comprised of a single fastener extending from top panel 21 and continuing around bag 12 to bottom panel 60, as shown in FIGS. 3 and 4. In an embodiment, zip fastener 32 may be disposed along at least a portion of the height of bag 12, as shown. For example, zip fastener 32 may extend about 3.5 cm in height on front panel 40. Fastener 32 may be comprised of a single fastener extending from top panel 21 of bag 12 and continuing around bag 12 to a rear panel 68, as shown in FIG. 5. Rear panel 68 is configured to be opposite of front panel 40. Fastener 32, in some embodiments, may extend about 3.5 cm in height on rear panel 68 of bag 12. Fastener 32 may be located on second end 18 of bag 12 approximately 4 cm inward from an outer edge of second end 18. It can be appreciated that fastener 32 may be configured to be unzipped starting at either end of fastener 32. For example, in an embodiment, fastener 32 may begin at the location shown in FIG. 5 and end at the location shown in FIG. 4.

As best seen in FIG. 5, opening 50 may disposed on second end 18 of bag, approximately at the center, as shown. Opening 50 may be configured to dispense fresh pet animal waste collection bags to allow a user (e.g., pet owner) to pull a bag individually, as needed.

In an exemplary embodiment, a release clip 71 (e.g., clasp strap) may be disposed on rear panel 68, as shown in FIG. 5. In one embodiment, release clip 71 may be disposed on second end 18 of elongate body 14. Release clip 71 may comprise 15 mm nylon webbing in some embodiments. In an exemplary embodiment, clip 71 may be used to releasably couple bag 12 with a secondary device (e.g., pet owner's leash, pet animal's pet collar, etc.). A hook-and-loop fastener 73 (e.g., Velcro strap) may also be disposed on rear panel 68, as shown in FIG. 5. Fastener 73 may similarly be used as clip 71. In an exemplary embodiment, clip 71 may be located approximately 6.35 cm apart from fastener 73. In some embodiments, clip 71 may be located up to 2 cm closer to fastener 73 or up to 2 cm farther from fastener 73. In an embodiment, fastener 73 may be comprised of two opposing free tabs (e.g., eight cm positive and negative strips attached at opposing ends of panel 68) that may be configured to releasably couple bag 12 to a secondary device. Fastener 73 may be comprised of a lineal fabric strip with tiny hooks such as VELCRO®. In an exemplary embodiment, fastener 73 may be disposed on first end 16 of elongate body 14. In other embodiments, release clip 71 may be disposed on first end 16 while fastener 73 may be disposed on second end 18. It can be appreciated that both clip 71 and fastener 73 may be adjustable in some embodiments of the present disclosure according to the user's needs (e.g., expanding the fastener and/or clip to coupleably secure an item to bag 12 or to coupleably secure bag 12 to a pet animal's leash or collar). It can also be appreciated that clip 71 and/or fastener 73 may be employed to coupleably secure a bag for any suitable reason the user may require. In some embodiments of the present disclosure, panel 68 may include two clips and zero fasteners, two fasteners and zero clips, or a combination of multiple clips and/or fasteners.

In an exemplary embodiment, rear panel 68 of bag 12 may be 22 cm in width and 8.5 cm in height. In another embodiment, rear panel 68 may be sized such that first end 16 is two cm in width, elongate body 14 is 14 cm in width, and second end 18 is four cm in width to total 22 cm in total width.

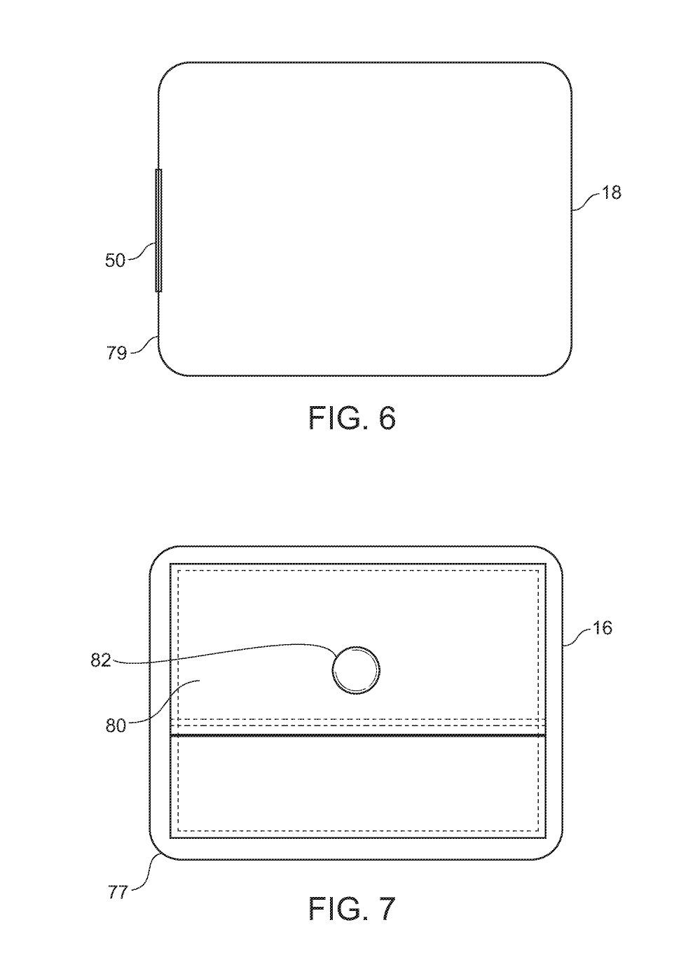

With reference now to FIGS. 6 and 7, first and second end views of the exemplary pet waste collection system of FIG. 1 are shown. FIG. 6 depicts a side view of a second side panel 79 corresponding to second end 18 of bag 12. In an embodiment, opening 50 may be located on bag 12 as shown in FIG. 6. Opening 50, as previously disclosed, may be configured to dispense fresh pet animal waste bags as needed by a user (e.g., pet owner). In some versions of the system, side panel 79 may be referred to as the “top” of bag 12.

Similarly, FIG. 7 depicts a side view of a first side panel 77 corresponding to first end 16 of bag 12. As alluded to earlier in this disclosure, panel 77 may be representative of expandable first compartment 42 of first end 16. As zip fastener 30 is unzipped, first compartment 42 may expand to permit a user to insert personal items. In some versions of the system, side panel 77 may be referred to as the “bottom” of bag 12.

A side pocket 80 may be disposed on first side panel 77, as shown. A button 82 may be used to coupleably open and close pocket 80. Pocket 80 and button 82 may be referred to as a gun metal poppered pocket in an embodiment. In some embodiments, button 82 may be comprised of a snap button, clip, hook-and-loop fastener, buckle or other similar feature. Side pocket 80 may be stitched to panel 77 as depicted in FIG. 7. Pocket 80 may be configured to store the user's personal items of value (e.g., cash, debit card, ID card, etc.).

As also alluded to earlier in this disclosure, second side panel 79 may be representative of second compartment 44 of second end 18. Second side panel, including second compartment 44, may be configured to store or hold a fresh supply of pet animal waste collection bags (e.g., dog fecal waste bags). Opening 50, as previously described, may be disposed at an outer edge of second side panel 79. In an exemplary embodiment, opening 50 is located at the intersection of front panel 40 and second side panel 79 to permit a user to retrieve a fresh waste collection bag from bag 12.

Fluorescent piping may be added to any edge or outer border of each panel described in this disclosure. Fluorescent piping may also be added to any edge or outer border of lid 24, or to any other edge of bag 12 not described in this disclosure. Fluorescent piping may be formed from material capable of glowing at night (e.g., to illuminate bag 12 at night when a pet owner is walking his/her pet animal).

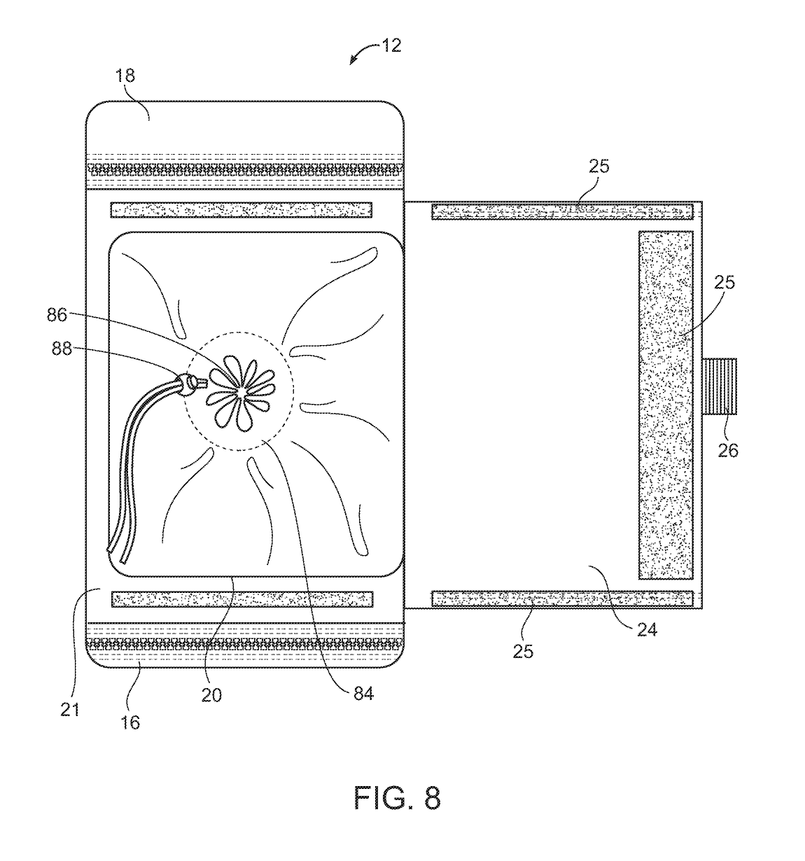

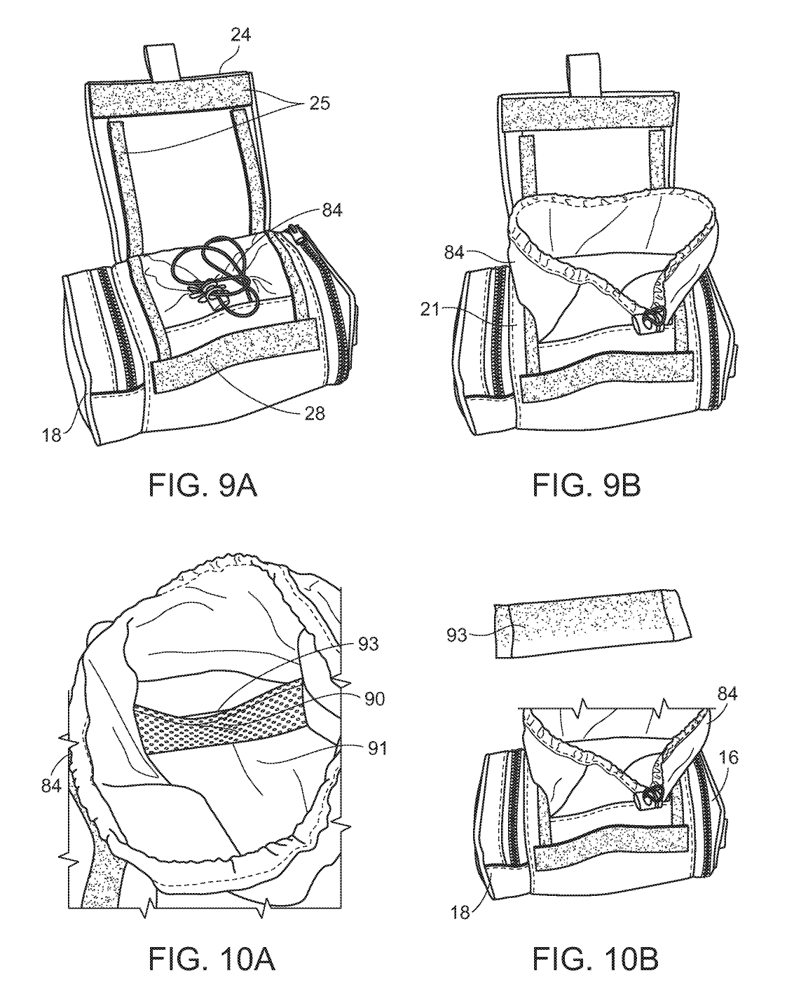

With reference now to FIGS. 8, 9A-9B, and 10A-10B, a drawstring pouch 84 is now described. In an exemplary embodiment, drawstring pouch 84 may be secured within opening 20 of bag 12. Pouch 84 may be secured within bag 12, for example, by stitching an outer bottom surface of pouch 84 to a base (not identified) of elongate body 14 disposed within the cavity defined by opening 20. Pouch 84, along with opening 20, may be configured and dimensioned appropriately to ensure that fecal matter stored within bag 12 does not squish when a user (e.g., pet owner) adds additional used pet animal waste bags within bag 12. In other words, bag 12 may provide a user (e.g., pet owner) with sufficient space to allow multiple bags of pet waste to be stored without squishing the used bags inside opening 20 of bag 12. In an exemplary embodiment, pouch 84 may include an upper skirt section that may extend approximately nine mm above the surface of top panel 21, as shown in FIG. 9B. It can be appreciated the upper skirt section may extend greater or less than nine mm above the surface of top panel 21. For example, upper skirt may extend nine cm plus or minus 10%, 15% or 20% in various embodiments. Upper skirt may be configured and dimensioned to make bag 12 as sanitary as possible.

In some embodiments, pouch 84 may be configured to open and close by the user using a drawstring, or any other suitable mechanism. For example, pouch 84 may be configured to open or close to store used pet waste collection bags by the user (e.g., store used pet waste litter bags containing pet fecal matter). A user may draw on the drawstring by depressing or pressing a button to open or close the upper skirt section as needed, or as required, when the user intends to store pet waste in bag 12. Pet waste may be stored within pouch 84 temporarily until the user encounters a proper and legal waste receptacle. During operation of system 10, pet waste may be collected in a pet waste litter bag, or other suitable waste collection element, and deposited within pouch 84. At a next step, drawstring of pouch 84 may be pulled to close pouch 84, and lid 24 may be subsequently pulled down to close opening 12; thus, closing bag 12, which now includes the retrieved pet waste in pouch 84.

Without opening pouch 84, as shown in FIG. 9A, bag 12 may comprise a height of approximately 7.62 cm. In some embodiments, it can be appreciated bag 12 may comprise a total height that is 20% greater or 20% less than 7.62 cm.

In an exemplary embodiment, pouch 84 may be formed from a waterproof material (e.g., nylon). Pouch 84 may employ an elastic drawstring neck 86 with a toggle fastener 88. In some embodiments, toggle fastener 88 may be two mm elastic. Pouch 84 may also be formed from a waterproof nylon inner bag lining opening 20 of elongate body 14. In some embodiments, pouch 84 may be formed with seams that may be taped to prevent leaks. For example, seams around pouch 84 may be taped to prevent leaked fluid from pet animal waste from entering the remaining compartments of bag 12. In some embodiments, a dividing wall or panel (e.g., foam, pad, or other suitable material) may be inserted between opening 20 of elongate body 14 and adjacent first and second compartments 42, 44 of first and second ends 16, 18, respectively. Dividing panels may be employed to create a wall between opening 20 in which fecal matter may be deposited in pouch 84 and the user's personal items/fresh pet waste litter bags stored in first and second compartments 42, 44. In an exemplary embodiment, dividing walls or panels may be located within first and second compartments 42, 44.

In an exemplary embodiment, and with reference now to FIGS. 10A-10B, a mesh pocket 90 may be disposed within pouch 84 as shown. In an exemplary embodiment, mesh pocket 90 may be secured (e.g., stitched) to an inner surface of pouch 84. Mesh pocket 90 may be secured to the dividing wall separating opening 20 and second end 18 of elongate body 14, as shown in FIG. 10B. A filter sachet 93 (e.g., a charcoal filter sachet) may be inserted within mesh pocket 90. Any seams created when mesh pocket 90 is stitched or otherwise secured within pouch 84 may be taped to prevent leaks, as alluded to earlier in this disclosure. Mesh pocket 90 may hold and secure sachet 93 during operation of system 10. In an embodiment, filter sachet is eight cm by three cm. In an exemplary embodiment, a charcoal filter sachet may be employed to deodorize and/or neutralize foul odors generated by used pet waste collection bags present within pouch 84. In an exemplary embodiment, filter sachet 93 may be used to absorb as much remnant odors as possible between uses of bag 12. For example, filter sachet 93 may be used to deodorize or neutralize odors within bag 12 overnight when bag 12 is not being used by the user (e.g., pet owner). Other materials suitable apart from charcoal useful for neutralizing these odors may also be employed. In some versions of bag 12, deodorant balls may be employed to neutralize and/or deodorize foul odors within bag 12.

In an exemplary embodiment, mesh pocket 90 may be mounted to an inner surface of pouch 84. Once mesh pocket 90 is mounted to pouch 84, mesh pocket may be secured (e.g., stitched or any other suitable manner) to a dividing wall, as previously described in this disclosure. Mesh pocket 90 may be secured to any dividing wall. In some versions of bag 12, multiple mesh pockets 90 may be employed to store multiple filter sachets 93 (e.g., charcoal filters, deodorant balls, etc.).

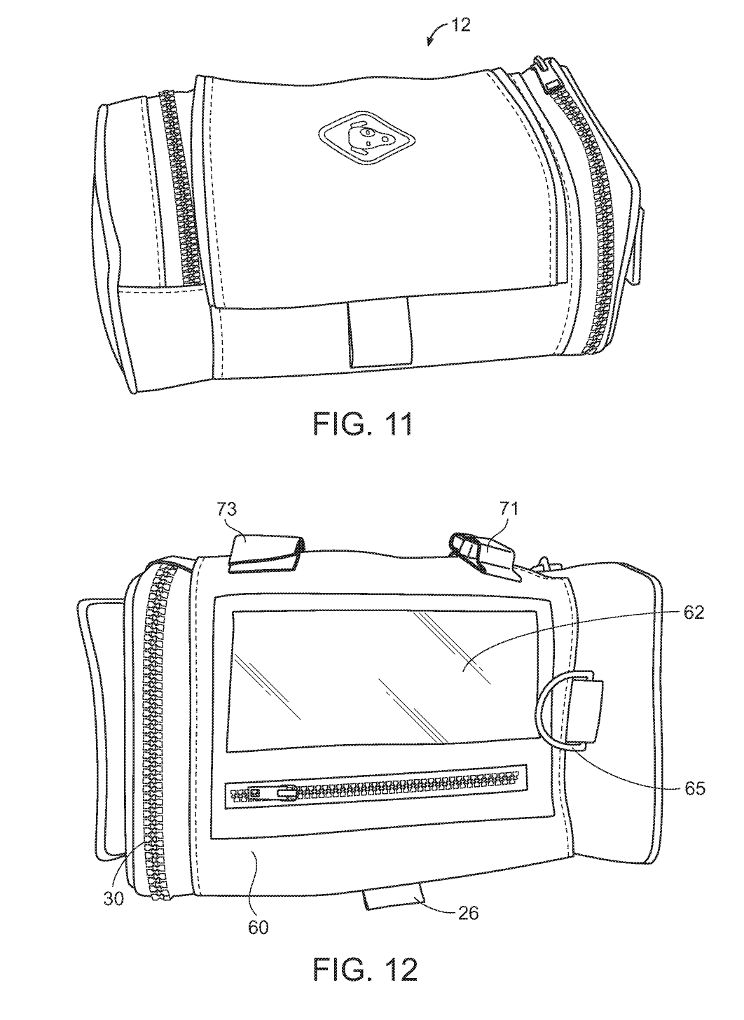

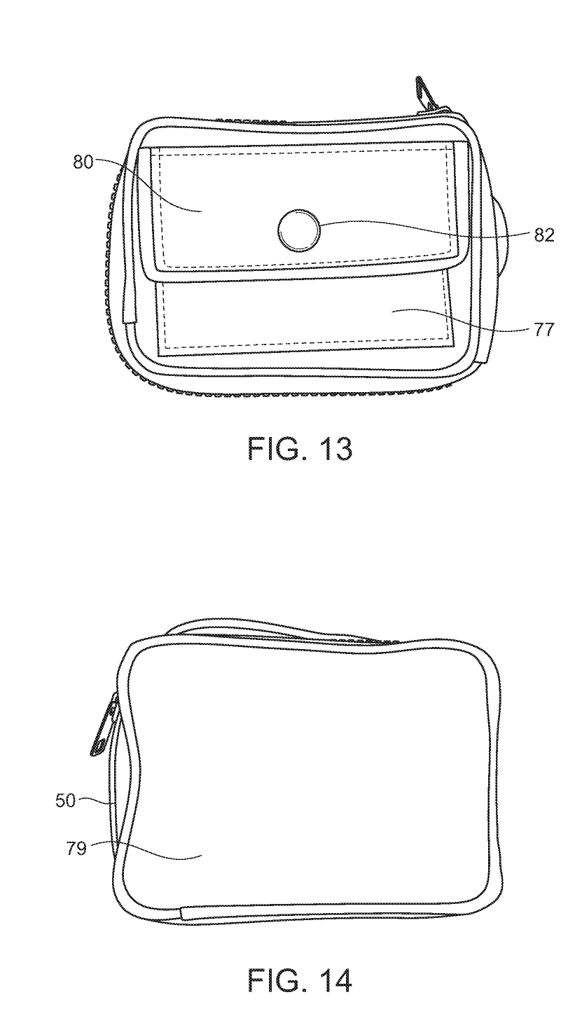

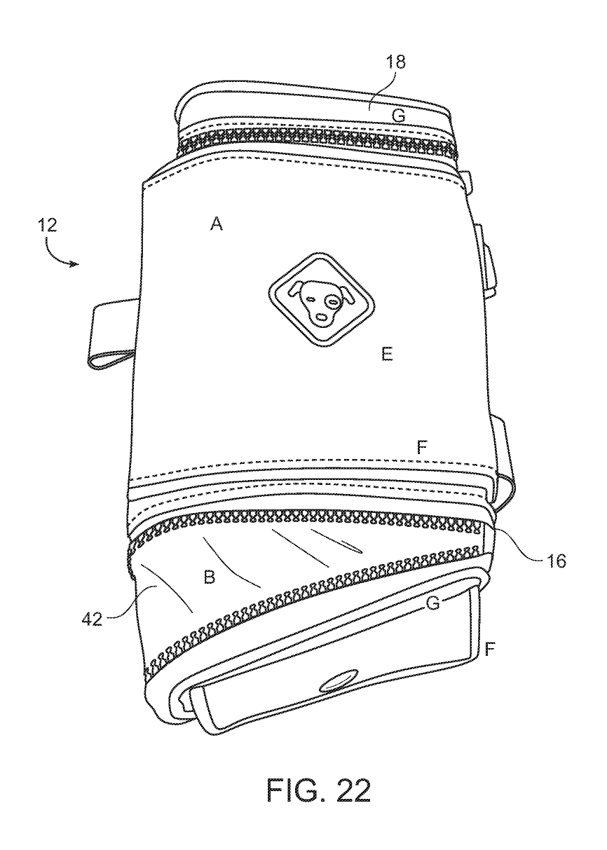

FIGS. 11-22 include additional perspective views of system 10 to further illustrate aspects of the present disclosure.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

1. A system comprising:
a pet waste accessory bag comprising:
an elongate body having a first end and a second end, the elongate body including an opening extending substantially from the first end to the second end;
a drawstring pouch mounted to a surface of the elongate body, wherein the drawstring pouch is configured and dimensioned to receive at least pet waste; and
a mesh pocket mounted to an inner surface of the drawstring pouch and located within the opening, wherein the mesh pocket is configured to receive a filter sachet.

2. The system of claim 1, wherein the drawstring pouch further comprises a base portion and a skirt portion.

3. The system of claim 1, wherein the surface of the elongate body is a bottom panel of the bag, and wherein the pouch base portion is mounted to the bottom panel.

4. The system of claim 1, wherein the skirt portion extends above the opening of the elongate body, and wherein the skirt portion is configured and dimensioned to receive the at least one bag of pet waste, and wherein the base portion is configured and dimensioned to store the at least pet waste.

5. The system of claim 1, wherein the skirt portion extends beyond the opening by approximately nine centimeters.

6. The system of claim 1, wherein a lid is pivotally connected to the elongate body.

7. The system of claim 1, wherein when the lid is closed the skirt section, the base section, and the mesh pocket are disposed entirely within the opening.

8. The system of claim 1, wherein the filter sachet comprises a deodorant.

9. The system of claim 1, wherein the pet waste includes at least one bag of pet waste.

10. A pet waste collection system comprising:
a pet accessory bag comprising:
an elongate body having a first end and a second end, the elongate body including an opening extending substantially from the first end to the second end;
a first compartment located at the first end, wherein a first dividing wall is configured to separate the opening with the first compartment;
a second compartment located at the second end, wherein a second dividing wall is configured to separate the opening with the second compartment;
a lid pivotally attached to the elongate body;
a bag comprising a first section and a second section, wherein the bag first section is mounted to a base of the elongate body; and
a pocket mounted to an inner surface of the bag first section, wherein the pocket is configured and dimensioned to receive a filter sachet.

11. The pet waste collection system of claim 10, wherein at least one fastener mounted to the lid is adapted to secure the lid to at least one fastener mounted to the elongate body, and wherein when the lid is closed the opening is covered.

12. The pet waste collection system of claim 10, wherein when the lid is closed, the bag first section, the bag second section, and the pocket are sealed within the bag.

13. The pet waste collection system of claim 10, wherein the bag is a waterproof drawstring pouch.

14. The pet waste collection system of claim 10, wherein the bag second section comprises a skirt-like shape, and wherein the bag second portion extends above the opening of the elongate body.

15. The pet waste collection system of claim 10, wherein the bag second section extends beyond the bag opening by approximately nine centimeters.

16. The pet waste collection system of claim 10, wherein the bag second section is configured and dimensioned to receive one or more bags of pet waste, and wherein the bag first section is configured and dimensioned to store the one or more bags of pet waste.

17. The pet waste collection system of claim 10, wherein the first compartment is configured to expand via a zip fastener.

18. The pet waste collection system of claim 10, wherein the second compartment further comprises a supply opening, wherein the second compartment is configured and dimensioned to store at least one fresh pet waste bag, and wherein the supply opening is configured and dimensioned to permit a user to individually retrieve the fresh pet waste bag from the supply opening.

19. The pet waste collection system of claim 10, wherein the filter sachet is a charcoal filter.

20. The pet waste collection system of claim 10, wherein the charcoal filter is a deodorant.
